(19) United States
(12) Patent Application Publication
(10) Pub. No.: US 2026/0340929 A1
(43) Pub. Date: Oct. 29, 2026

(54) METHOD AND DEVICE FOR GENERATING AN OUTSIDER PERSPECTIVE IMAGE AND METHOD OF TRAINING A NEURAL NETWORK

(71) Applicant: Continental Autonomous Mobility Germany GmbH, Ingolstadt (DE)

(72) Inventors: Michael Colin Hoy, Singapore (SG); Rahul Singh, Singapore (SG); Charlotte Gloger, Ulm (DE); Markus Friebe, Gefrees (DE)

(73) Assignee: Continental Autonomous Mobility Germany GmbH, Ingolstadt (DE)

(21) Appl. No.: 19/106,126

(22) PCT Filed: Aug. 16, 2023
(86) PCT No.: PCT/EP2023/072489

§ 371 Date: Feb. 24, 2025

(30) Foreign Application Priority Data
Aug. 23, 2022 (GB) 2212212.1

(51) Int. Cl. G06T 15/20; G06N 20/00; G06T 17/20

(52) U.S. Cl. CPC G06T 15/20; G06N 20/00; G06T 17/20

(57) ABSTRACT

According to various embodiments, a computer-implemented method for generating an outsider perspective image may be provided. The method may include receiving a plurality of input images that capture surroundings of an object. The method may further include projecting each input image of the plurality of input images, onto a respective virtual surface of a set of virtual surfaces around the object to generate a set of surface images. The method may further include projecting each surface image of the set of surface images onto a common coordinate frame, to generate a transformed dataset. The method may further include generating, by a machine learning model, an outsider perspective image based on the transformed dataset.

### CROSS-REFERENCE TO RELATED APPLICATIONS

The present application is a National Stage Application under 35 U.S.C. § 371 of International Patent Application No. PCT/EP2023/072489 filed on Aug. 16, 2023, and claims priority from Great Britain Patent Application No. 2212212.1 filed on Aug. 23, 2022, in the United Kingdom Intellectual Property Office, the disclosures of which are herein incorporated by reference in their entireties.

### TECHNICAL FIELD

Various embodiments relate to methods and devices for generating an outsider perspective image, and methods for training a neural network.

### BACKGROUND

Automotive Surround View (SV) systems play an important role in assisting drivers in driving functions, such as parking and other maneuvers. SV systems also improve road safety, as they provide the driver with viewpoints around their vehicle and thereby removing blind spots. SV systems may include multiple cameras, and a processor that stitches the camera data of the multiple cameras, to generate a 360° view around the vehicle. These SV systems typically project the camera images on a fixed bowl approximation and stitch the images together. As these camera images are not projected onto a correct modelling of the environment, distortions and doubling of objects may be visible in the generated view. One approach to reduce the distortions, is to deform the bowl approximation based on static object information of the environment, for a more accurate representation of the environment. To implement such a solution, information on the distance between the static object and the vehicle is required. Most neural network-based approaches assume the presence of at least some estimate of the depth of the surrounding scene, that may provide the distance information. However, such approaches have various shortcomings. For example, if the cameras are mounted at a low position on the vehicle, monocular and binocular depth estimations may be inaccurate. Also, it can be challenging for a single neural network to render the projections accurately for outdoor scenes where there are a wide range of different distance scales to consider. In addition, it is also useful in driver assistance applications, to provide the driver with a third person viewpoint, also referred herein as outsider perspective image, that allows the driver to look at his vehicle and its surroundings, as if the driver is outside of the vehicle. However, the neural network-based approaches described above are not applied to generating the third person viewpoint. These approaches also do not generalize well to multiple vehicle types.

In view of the above, there is a need for an improved method for generating outsider perspective images, that can address at least some of the abovementioned problems.

### SUMMARY

According to various embodiments, there is provided a computer-implemented method for generating an outsider perspective image. The method may include receiving a plurality of input images that capture surroundings of an object. The method may further include projecting each input image of the plurality of input images, onto a respective virtual surface of a set of virtual surfaces around the object to generate a set of surface images. The method may further include projecting each surface image of the set of surface images onto a common coordinate frame, to generate a transformed dataset. The method may further include generating, by a machine learning model, an outsider perspective image based on the transformed dataset.

According to various embodiments, there is provided a device for generating an outsider perspective image. The device may include a processor configured to perform the above-described method.

According to various embodiments, there is provided a use of the above-described device, for teleoperating a vehicle.

According to various embodiments, there is provided a computer-implemented training method for training a machine learning model. The training method may include projecting each training image of a plurality of training images that capture surroundings of a training object, onto a respective virtual surface of a set of virtual surfaces around the training object to generate a set of surface images. The training method may further include projecting each surface image of the set of surface images onto a common coordinate frame, to generate a training dataset. The training method may further include training the machine learning model, using the training dataset as an input to the machine learning model, and further using a set of ground truth outsider perspective images that correspond to the plurality of training images as a training signal.

According to various embodiments, there is provided a data structure generated by the above-described training method.

Additional features for advantageous embodiments are provided in the dependent claims.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. In the following description, various embodiments are described with reference to the following drawings, in which:

FIG. 1A shows a simplified functional block diagram of a device for generating an outsider perspective image, according to various embodiments.

FIG. 1B shows a simplified hardware block diagram of the device according to various embodiments.

FIG. 2A shows a top view of an object equipped with an SV system according to various embodiments.

FIG. 2B shows a 3D representation of a set of virtual surfaces around the object of FIG. 2A, according to various embodiments.

FIG. 3 shows a flow diagram of a method for generating an outsider perspective image 120, according to various embodiments.

FIG. 4 shows a block diagram of an example of the neural network, according to various embodiments.

FIG. 5 shows a block diagram of the machine learning model according to various embodiments.

FIG. 6 shows a flow diagram of a method for training a machine learning model, according to various embodiments.

FIGS. 7A and 7B show examples of equipment set-up for collecting the ground truth outsider perspective images.

### DETAILED DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled, as communicatively coupled, for example to receive and transmit data wirelessly or through wire, or as mechanically coupled, for example attached or fixed, or just in contact without any fixation, and it will be understood that both direct coupling or indirect coupling (in other words: coupling without direct contact) may be provided.

The term “outsider perspective image” may be interchangeably referred to as “third person image”, or “third person view image”.

The term “ground truth images” may refer to real images, i.e. images directly captured by a camera, while generated viewpoints may refer to synthetic images generated by a system, or a machine learning model.

The term “coordinate frame” may refer to a set of three vectors having unit length and which make a right angle with one another, and may serve as a reference for defining positions.

In this context, the device as described in this description may include a memory which is for example used in the processing carried out in the device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In order that the present disclosure may be readily understood and put into practical effect, various embodiments will now be described by way of examples and not limitations, and with reference to the figures.

According to various embodiments, a visualization method for an advanced driver assistance system (ADAS) may be provided. The visualization method may include synthesizing a viewpoint based on inputs from a surround view system of a vehicle. The synthesized viewpoint may allow the driver to look at his/her vehicle in its environment, from a virtual position. The synthesized viewpoint may be referred to as ‘novel’, as the vehicle itself has no sensors positioned at the virtual position. The visualization method may synthesize the novel viewpoint by projecting images captured by the surround view system, onto virtual surfaces that surround the vehicle, and then re-projecting all of the projected images onto a common viewpoint, or coordinate frame. The reprojected image data may be used, in conjunction with ground truth images from the common viewpoint, to train a machine learning model. The synthesized viewpoint may include a third person view, also referred herein as an outsider perspective view. The common viewpoint may be the viewpoint of the outsider perspective view.

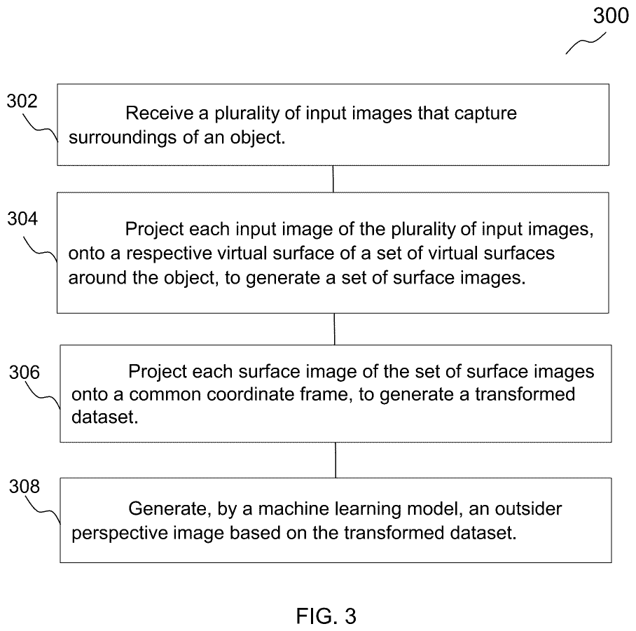

Advantageously, the visualization method may provide the driver with a view of his/her vehicle relative to its environment, that may assist the driver in maneuvering the vehicle. For example, the synthesized viewpoint may allow the driver to see what is behind or beside the vehicle, so that the driver may maneuver in a tight space without scratching his vehicle. The visualization method may include a method 300 of generating an outsider perspective view image, as described subsequently with respect to FIG. 3.

In addition to being used in the context of ADAS, the visualization method may also be useful in other applications, for example, teleoperation of automobiles, robots and other machinery, by offering the controller or driver of the machinery a different viewpoint that is not directly available through sensors installed on the machinery.

The visualization method may also be useful in simulation of autonomous vehicles, for example, generating different viewpoints of the autonomous vehicles that show the vehicles' positions relative to their surroundings.

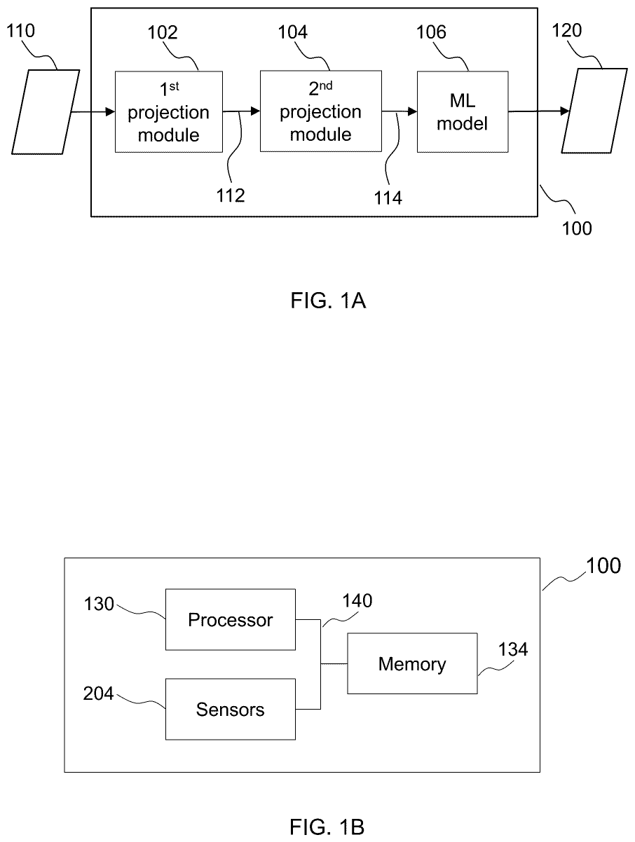

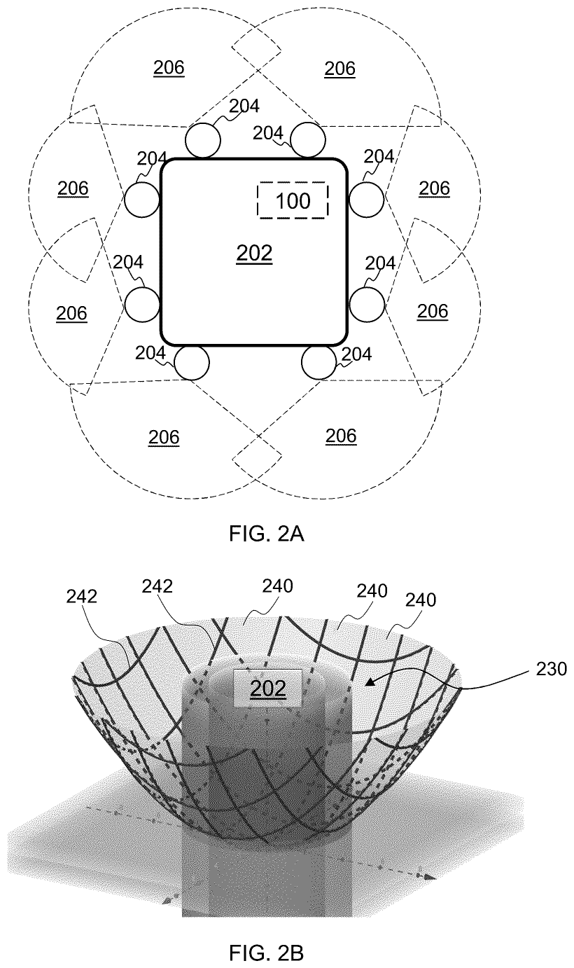

FIG. 1A shows a simplified functional block diagram of a device 100 for generating an outsider perspective image, according to various embodiments. The device 100 may also be referred herein as a visualization device. The device 100 may be capable of carrying out of the visualization method described above. The device 100 may include a first projection module 102. The first projection module 102 may be configured to receive a plurality of input images 110. The plurality of input images 110 may capture surroundings of an object 202 (shown in FIG. 2). The first projection module 102 may be configured to project each input image 110 of the plurality of input images 110 onto a respective virtual surface of a set of virtual surfaces around the object 202, to generate a set of surface images 112. The set of virtual surfaces may define a three-dimensional (3D) space around the object 202. The 3D space may at least partially surround the object 202. The device 100 may further include a second projection module 104 configured to project each surface image 112 of the set of surface images 112 onto a common coordinate frame, to generate a transformed dataset 114. The transformed dataset 114 may approximate images taken by a virtual camera at the common coordinate frame. In an embodiment, the common coordinate frame may be the coordinate frame of a virtual camera that captures the outsider perspective image 120. In another embodiment, the common coordinate frame may represent a bird's eye view. The device 100 may further include a machine learning model 106 configured to generate an outsider perspective image 120, also interchangeably referred herein as a third person view image, based on the transformed dataset 114. The outsider perspective image 120 may approximate a ground truth outsider view of the object 202 and its surrounding. The outsider perspective image 120 may approximate the view point a person standing outside of the object 202 and looking towards the object 202.

The machine learning model 106 may be trained with training data that include images that are projected, and reprojected by the first projection module 104 and the second projection module, similar to the transformed dataset 114. In other words, the method may include structuring multiple reprojections of the input image as an input data to the machine learning model 106. By doing so, the machine learning model 106 may be exposed to many different projections of the input images 110, and the machine learning model 106 may cross correlate these different projections to determine depth of objects captured in the input images 110.

In prior art solutions, a standard depth estimation neural network may detect objects in an image, determine size of the object in the image, infer a real size of the object by recognizing the object type, and estimate a depth of the object based on the size of the object in the image and the inferred real size. Prior art solutions may then use the estimated depth information to perform a geometric transformation of the image to a new viewpoint such as the outsider perspective image. However, errors in the depth estimation may cause deformation in the rendered image.

The device 100, however, may perform multiple projections of the input images 110, to generate “provisional” parts of the outsider perspective image 120. If the “virtual surface” happens to match the actual depth map of the scene, then the final projection may be accurate. The machine learning model 106 may differ from the prior art standard depth estimation neural network, in that it does not estimate depth, but rather, estimate which of the provisional projections may be the most accurate for the desired viewpoint. Generally, the task of estimating which provisional projections matches the desired viewpoint may be easier for the machine learning model 106, and hence, may be less computationally intensive while achieving better accuracy, as compared to estimating the depth of various objects in the input images 110. The machine learning model 106 may stitch together the provisional projections that match the desired viewpoint, to form the outsider perspective image 120. The machine learning model 106 may also make some adjustments, for example, to fill in missing pixels, or to add in a synthetic image of an object, into the outsider perspective image 120.

FIG. 1B shows a simplified hardware block diagram of the device 100 according to various embodiments. The device 100 may include at least one processor 130. The device 100 may further include a plurality of sensors 204. Each sensor 204 of the plurality of sensors 204 may be configured to capture a respective input image 110 of the plurality of input images 110. The at least one processor 130 may be configured to carry out the functions of at least one of the first projection module 102, the second projection module 104 and the machine learning model 106. The device 100 may further include at least one memory 134. The at least one memory 134 may include a non-transitory computer-readable medium. The at least one processor 130, the plurality of sensors 204 and the at least one memory 134 may be coupled to one another, for example, mechanically or electrically, via the coupling line 140.

The device 100 may be, in one example, be suitable for use in association with at least one vehicle and/or at least one vehicle related application. The device 100 may, in another example, be suitable for use in association with a vehicle computer (e.g., a vehicle dashboard computer) which may be configured to render one or more alternate viewpoints based on data communicated from, for example, a surround view camera for the purpose of providing driver assistance. In yet another example, the device 100 may be suitable for use in association with a vehicle teleoperation console which may be configured to render one or more (appropriate) viewpoints to enable teleoperation based on data from a, for example, surround view camera (e.g., communicable over a network such as a communication network). In yet another additional example, the device 100 may be suitable for use in association with a simulation system for an autonomous vehicle which can be configured to render one or more current virtual viewpoints of a simulated vehicle inside a scene based on, for example, a multitude of camera images associated with a real scene, in accordance with an embodiment of the disclosure. Other examples (e.g., which may not be related to vehicles and/or vehicle related applications) such as computer gaming, virtual 3D (3 dimensional) touring (e.g., of one or more places of interest) and/or providing a 3D virtual experience (e.g., via a browser, via a desktop application and/or via a mobile device app etc.) may possibly be useful, in accordance with embodiment(s) of the disclosure.

According to an embodiment which may be combined with any above-described embodiment or with any below described further embodiment, the object 202 may be a vehicle. The device 100 may thus be configured to generate the outsider perspective image that provides a view of the vehicle relative to its environment. The outsider perspective image may provide a driver, or an operator (for a remotely-operated vehicle), with enhanced situational awareness for maneuvering the vehicle.

According to an embodiment which may be combined with any above-described embodiment or with any below described further embodiment, the device 100 may include the object 202. For example, the device 100 may be a driving system that includes the vehicle, and a visualization module that generates the outsider perspective image for facilitating control of the vehicle.

According to an embodiment which may be combined with any above-described embodiment or with any below described further embodiment, the device 100 may include software that generates the outsider perspective image. The device 100 may include a server that runs the software. The server may be external to the object 202, for example, may be a cloud-based computing server that renders the images offline. Having the images rendered offline may allow the use of more powerful processors that may be shared across multiple devices 100 or vehicles, instead of having to install dedicated expensive processors in each device 100.

According to an embodiment which may be combined with any above-described embodiment or with any below described further embodiment, the vehicle may include a dashboard. The dashboard may be configured to display the outsider perspective image, to provide driver assistance for maneuvering in tight spaces. Optionally, the dashboard may include a touchscreen display. Displaying the outsider perspective image on the dashboard may allow the driver to view the vehicle's position without taking his eyes off the road. The touch screen display may allow the driver to quickly select his preferred viewpoint.

According to an embodiment which may be combined with any above-described embodiment or with any below described further embodiment, the processor 130 of the device 100 may be configured to execute a method 300 (shown in FIG. 3).

FIG. 2A shows a top view of an object 202 equipped with a surround view (SV) system according to various embodiments. The object 202 may be a vehicle. The object 202 may be coupled to the device 100, or may include the device 100. The SV system may include a plurality of sensors 204. The sensors 204 may include at least one of camera, LiDAR and radar. The plurality of sensors 204 may be respectively arranged at a corresponding plurality of different positions of the object 202, so that each sensor 204 faces a different direction from the other sensors 204. Each sensor 204 may have its respective field of view (FOV) 206. The plurality of sensors 204 may include a variety of sensors, for example, a mixture of camera and radar. The plurality of sensors 204 may also have a variety of FOVs 206. For example, the sensors 204 on the left and right sides of the object 202 may have smaller FOVs 206 as compared to sensors 204 on the front and rear ends of the object 202. The FOVs 206 of the plurality of sensors 204 may overlap, such that the combined FOVs 206 of the plurality of sensors 204 cover a region surrounding the object 202. The plurality of sensors 204 may be also referred herein as Surround View (SV) sensors, as they collectively capture information on the surroundings of the object 202. The images captured by the sensors 204 may be referred herein as SV images, and may form the input images 110.

According to various embodiments, the object 200 may be a vehicle. It will be understood by a person skilled in the art, that in the context of automotive applications, SV may refer to an automotive technology that provides the driver of the vehicle a 360-degree view of the area surrounding the vehicle. An SV system may typically include four to six fish-eye cameras mounted on the vehicle. The plurality of sensors 204 may be part of an SV system, for example, fish-eye cameras of the SV system. The device 100 may be part of an SV system, and may be configured to generate the outsider perspective image 120 based on image data captured by the sensors 204.

FIG. 2B shows a 3D representation of a set of virtual surfaces 240 around the object 202, according to various embodiments. The set of virtual surfaces 240 may at least partially define a 3D region 230 around the object 202. For example, the 3D region 230 may be a frusto-conically-shaped space around the object 202. The circumferential or peripheral surface of the 3D region 230 may include the set of virtual surfaces 240. The surface of the 3D region 230 may be divided into sub-regions referred herein as virtual surfaces 240. Each virtual surface 240 may be represented as a mesh, in between mesh lines 242. Each mesh may be represented by mesh parameters including vertex positions.

According to various embodiments, the device 100 may include a virtual surface generation neural network. The process for training the virtual surface generation neural network may include specifying each intermediate surface as a mesh, where the parameters of the mesh are the vertex positions (i.e. the edge connections between vertices are fixed). The training process may further include performing the projections and obtaining a loss function. The training process may include backpropagating the projections onto the mesh coordinates. Information on the training process may be found in “Advances in Neural Rendering” by Tewari et. al. The virtual surface generation neural network may be configured to generate the set of virtual surfaces. Advantageously, generating the set of virtual surfaces using the virtual surface generation neural network, instead of manually specifying the virtual surfaces may optimize the selection of surfaces, especially when there are many intermediate surfaces, thereby resulting in more provisional projections that may become part of the final output image.

FIG. 3 shows a flow diagram of a method 300 for generating an outsider perspective image 120, according to various embodiments. The method 300 may include processes 302, 304, 306 and 308. The process 302 may include receiving a plurality of input images 110 that capture surroundings of an object 202. The plurality of input images 110 may be, for example, captured by a plurality of sensors 204 coupled to the object 200, like shown in FIG. 2. The process 304 may include performing a first projection. The first projection may include projecting each input image 110 of the plurality of input images 110, onto a respective virtual surface of a set of virtual surfaces around the object 200. The object 200 may be represented in a virtual 3D space, for example, a computer model, and the set of virtual surfaces may be represented in the virtual 3D space as at least partially surrounding the object 200. The first projection may be carried out by the first projection module 102. As a result of the first projection, a set of surface images 112 may be generated. The process 306 may include a second projection. The second projection may include projecting each surface image 112 of the set of surface images 112 onto a common coordinate frame, to generate a transformed dataset 114. The second projection may be carried out by the second projection module 104. The process 308 may include generating an output outsider perspective image 120 by providing the transformed dataset 114 to a machine learning model 106.

Advantageously, the method 300 may be able to generate the outsider perspective image 120 without relying on depth estimates. Depth estimates obtained from camera images may be inaccurate due to mounting positions of the cameras, or calibration inaccuracies of the cameras. The first and second projections in the method 300 may transform the input images 110 to various different new viewpoints to generate provisional images. The machine learning model 106 may generate the outsider perspective image 120 by determining which of these provisional images is the most accurate.

The method 300 may include converting the input images 110 to a suitable form for being an input to the machine learning model 106, for example, the first projection and the second projection processes. The method 300 may include defining a set of surfaces in a 3D space around the object 202. An example of the set of surfaces may include a set of slanted planes at different elevation values where each plane may be restricted to a finite spatial region in the top down view. In another example, the set of surfaces may include a set of curved surfaces that collectively make up a “bowl” shape surrounding the object 202. If depth information of the surrounding of the object 202 is known, the set of surfaces may be computed adaptively based on the depth information, using piecewise smooth fitting techniques, such as at least one of expectation-maximization, MeanShift, random sample consensus (RANSAC), spectral clustering, Dirichlet processes, and robustified non-linear-least squares. In the first projection process, the input images may be projected onto the set of surfaces using standard projection based operations. In an alternative embodiment, instead of projecting the raw image values, for example, red-green-blue (RGB), to the set of surfaces, intermediate feature vectors extracted by the machine learning model 106 may be projected to the set of surfaces. In the second projection process, the data from each of the surfaces may be projected onto a common coordinate frame, which may then be used as the input to the machine learning model 106.

According to various embodiments, at least one of the first projection module 102 and the second projection module 104 may include a viewpoint rendering neural network. The viewpoint rendering neural network may be configured to render a novel viewpoint based on available image data, using viewpoint rendering methods such as image-to-image translation, neural point based rendering, online hypernetwork based neural radiance fields (NeRF), online image based NeRF, and geometry free autoregressive modelling. These viewpoint rendering methods are generally known to a person skilled in the art, and are briefly described in the following paragraphs

An image-to-image translation method may include transforming images into point clouds and projecting each pixel from equirectangular coordinates to Cartesian coordinates. For a desired target view, a nearest plurality of views may be chosen. For each chosen view, the point cloud may be transformed with a rigid body transformation and projected onto an equirectangular image. Another example of image-to-image translation method may include building a 3D scene mesh by wrapping a lattice grid, also referred herein as a mesh sheet, onto a scene geometry and then generating a novel view by moving a virtual camera in 3D space.

Neural point based rendering method may be similar to image-to-image translation method, except that the internal neural network features may be projected instead of the raw RGB pixel values. Also, for each pixel in the image to be generated, the viewpoint rendering neural network may collate a “buffer” of projected features corresponding to different distances to the camera origin.

Online hypernetwork based NeRF method may include performing online generation of an implicit model of the scene. An implicit model may be a mapping from image coordinates and incidence angles to color and transparency information.

Online image based NeRF may differ from the online hypernetwork based NeRF, in that during the ray tracing operations that generate the output image, instead of using an implicit model, the viewpoint rendering neural network may perform lookup operations against feature maps of the source images.

Geometry free autoregressive modelling may include using a high capacity neural network to learn to relate image patches and transformation parameters directly, with zero manual geometric transformations required as part of the neural network pipeline. Geometry free autoregressive modelling may be capable of handling large viewpoint changes, as it renders the output image patchwise, and may be able to ensure subsequent output image patches are consistent with the preceding image patches.

The neural viewpoint rendering approach may employ for example, image translation, point based rendering or an autoregressive model. In using these neural viewpoint rendering approaches, the common coordinate frame may be that of the output image, i.e. the desired outsider perspective viewpoint. This provides that advantage that the there is no further processing required to translate the common coordinate frame to the coordinate frame of the desired viewpoint.

The neural viewpoint rendering approach may employ, for example, online hypernetwork NeRF. In using online hypernetwork NeRF, the common coordinate frame may be a bird's eye view image.

According to an embodiment which may be combined with any above-described embodiment or with any below described further embodiment, the first and second projection steps may include re-rendering of images using a rendering neural network, such as at least one of learned denoising/infill, online neural radiance fields, neural point based graphics, and autoregressive models. The re-rendering of the images using the rendering neural network may produce approximations of many different viewpoints that may be used as inputs to the machine learning model 106. These many different viewpoints may simplify the problem that the machine learning model 106 has to solve, i.e. the machine learning model 106 may be trained to select the viewpoint that best matches the outsider perspective view instead of determining depth details of objects within the input image 110 and then reconstructing the outsider perspective view based on the depth details.

According to an embodiment which may be combined with any above-described embodiment or with any below described further embodiment, the method 300 may further include performing infill operations in the output image, i.e. the outsider perspective image 120. The device 100 may further include an infilling neural network trained to perform hierarchical infill operations. The method 300 may include downsampling the outsider perspective image 120 to a lower resolution The method 300 may further include identifying regions of interest, where there are empty pixels due to occlusion, in the downsampled image. The method 300 may further include applying the infilling neural network on the regions of interest, to generate image data for the empty pixels. The generated image data may be added to the downsampled image to obtain an intermediate infill image. Next, the infilling neural network may be applied to the entire intermediate infill image, to deblur, or add details, to obtain a processed infill image. The processed infill image may then be upsampled to a higher resolution, to provide an improved outsider perspective image 120 without missing pixel data. Performing the infill operations may complete the outsider perspective image 120, so that there are no empty pixels in the image.

According to an embodiment which may be combined with any above-described embodiment or with any below described further embodiment, the infilling process may include processing multiple planes of input data based on vector quantization (VQ) layer in VQ-VAE. The machine learning model 106 may include a vector quantization (VQ) layer specialized for processing data over multiple depth scales. Processing the multiple planes of input data based on VQ layer may include building a codebook of feature vectors, and for each feature vector in the feature map of each input layer, determining the nearest element of the codebook. The infilling process may further include computing a weighing for each of the input layers, for example, using a neural network. The infilling process may further include quantizing the feature vectors, computing the weighted average of the quantized vectors, and repeating the quantization process for the averaged vector. Advantageously, the VQ layer may stabilize the image rendering with smaller neural networks. Information on an example of the infilling neural network may be found in “Generating Diverse Structure for Image Inpainting with Hierarchical VQ-QAE” by Peng et. al.

According to an embodiment which may be combined with any above-described embodiment or with any below described further embodiment, the method 300 may further include generating a synthetic image of the object 202 based on a 3D virtual model of the object 202, and may further include adding the synthetic image of the object 202 to the outsider perspective image 120. The machine learning model 106 may be trained with training images that exclude the object 202, so that the machine learning model 106 may be capable of working with any input images obtained in relation to any type of object, for example, in the context of automotive application, the machine learning model 106 may generate outsider perspective images 120 without being unduly influenced by the vehicle type. The synthetic image of the object 202 may be added into the outsider perspective image 120, to approximate the ground truth view where the object 202 is present.

According to an embodiment which may be combined with any above-described embodiment or with any below described further embodiment, the machine learning model 106 may include a fully convolutional neural network 400. The fully convolutional neural network 400 may include an encoder network and a decoder network. The encoder network may include a plurality of convolution layers. When an image is input to a convolution layer, a convolution operation may pass with a kernel through the entire image. The output of the convolution operation may include the value of response to one or the other kernel in each point of the image. The output may go through a further convolution layer. After an image has been processed by a required number of convolution layers, it may then be provided to a pooling layer. The pooling layer may reduce the size of input images. The pooling layer may include a kernel that moves similarly to the convolution layer and may calculate an only value for each image area. Reducing the size of the images may speed up the data processing in the neural network 400. When the image size is reduced, convolution layers of the same size may be able to capture a greater part of the required features in the images. The sequence of convolution layers followed by pooling layers may be repeated multiple times until a minimum image size is obtained. The minimum image size may be determined experimentally.

The decoder network may include upsampling layers and convolution layers. Features highlighted by the encoder network may be enlarged using upsampling layers, so that they revert to the initial size. The decoder network and the encoder network may be symmetric. The decoder network may include convolution layers between the upsampling layers, but the number of outputs from these convolution layers may decrease as the images progress through the decoder network. The repeated sequence of an upsampling layer followed by convolution layers may bring the image back to its initial size while reducing the number of possible image interpretations to the number of the required features.

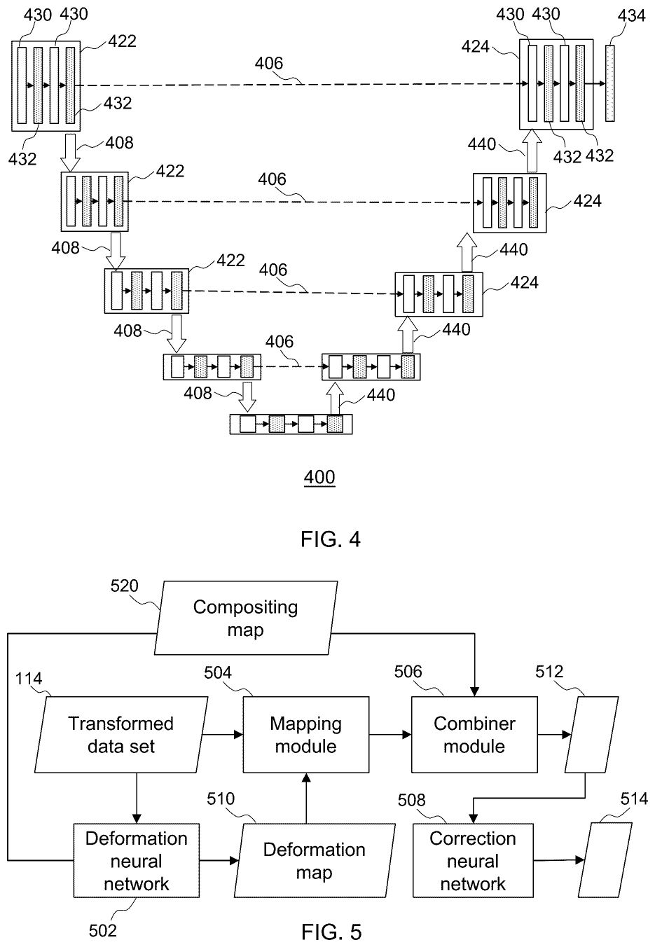

An embodiment of the neural network 400 is described further with respect to FIG. 4.

According to an embodiment which may be combined with any above-described embodiment or with any below described further embodiment, training of the neural network 400 may, for example, be based on standard backpropagation based gradient descent. As an example how the neural network 400 may be trained, a training dataset may be provided to the neural network 400, and the following training processes may be carried out.

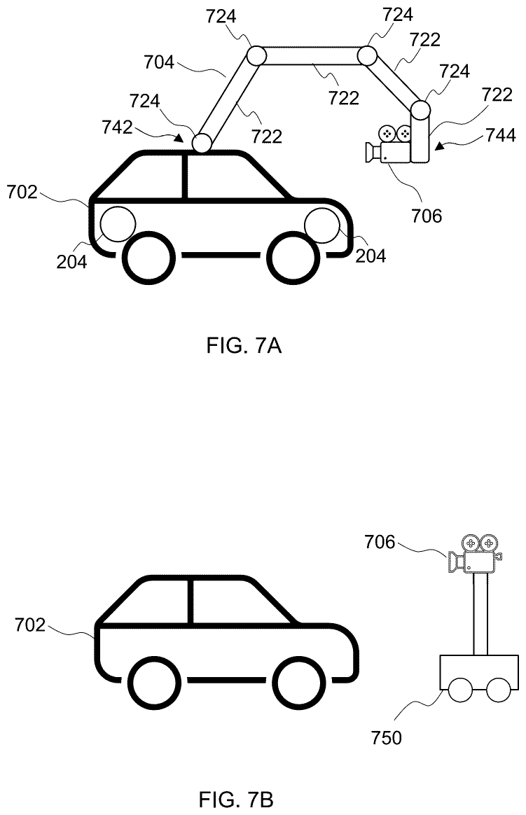

A training dataset may be generated by collecting ground truth outsider perspective images, for example, according to methods described with respect to FIGS. 7A and 7B. Alternatively, an example of a suitable training dataset for training the correction neural network 508 may be the public-based database RealEstate10k.

The ground truth outsider perspective images may serve as a training signal to the neural network 400. The training dataset may further include a plurality of surround view images captured by surround view cameras installed on a vehicle. These surround view images may be processed to mask off the vehicle, for example body of the vehicle.

Before training the neural network 400, the weights may be randomly initialized to numbers between 0.01 and 0.1, while the biases may be randomly initialized to numbers between 0.1 and 0.9.

Subsequently, the first observations of the dataset may be loaded into the input layer of the neural network and the output value(s) is generated by forward-propagation of the input values of the input layers. Afterwards the following loss function may be used to calculate loss with the output value(s):

Mean Square Error (MSE):

$$MSE = \frac{1}{n} \sum {( y - \hat{y} )}^{2} ,$$

where n represents the number of neurons in the output layer and y represents the real output value and ŷ represents the predicted output. In other words, y−ŷ represents the difference between actual and predicted output.

The weights and biases may subsequently be updated by an AdamOptimizer with a learning rate of 0.001. Other parameters of the AdamOptimizer may be set to default values. For example:
beta_1=0.9
beta_2=0.999
eps=1e-08
weight_decay=0

The steps described above may be repeated with the next set of observations until all the observations are used for training. This represents the first training epoch. This may be repeated until 10 epochs are completed.

According to an embodiment which may be combined with any above-described embodiment or with any below described further embodiment, the fully convolutional neural network 400 may include a U-Net architecture. In U-Net, there are a large number of feature channels in the upsampling part, which allow the network to propagate context information to higher resolution layers. As a consequence, the expansive path is more or less symmetric to the contracting part, and yields a u-shaped architecture. The network only uses the valid part of each convolution without any fully connected layers. To predict the pixels in the border region of the image, the missing context may be extrapolated by mirroring the input image. This tiling strategy may allow the neural network to be applied to large images, since otherwise the resolution would be limited by the memory of a graphics processing unit or a processor of the device 100.

According to an embodiment which may be combined with any above-described embodiment or with any below described further embodiment, the machine learning model 106 may include a deformation neural network 502. The deformation neural network 502 may be configured to generate a deformation map 510 and a compositing map based on the transformed dataset 114. The machine learning model 106 may include a mapping module 504 configured to map each surface image of the set of surface images based on the deformation map 510, to generate a set of remapped images. The machine learning model 106 may further include a combiner module 506 configured to combine one or more of the remapped images based on the compositing map, to generate the outsider perspective image 120. The deformation neural network is described further with respect to FIG. 5. Generating the deformation map and composition map, instead of the outsider perspective image directly, may provide the advantage of reducing the computational complexity required from the neural network. The deformation neural network 502 is described further with respect to FIG. 5.

According to an embodiment which may be combined with any above-described embodiment or with any below described further embodiment, training of the deformation neural network 502 may, for example, be based on standard backpropagation based gradient descent. As an example how the deformation neural network 502 may be trained, a training dataset may be provided to the deformation neural network 502, and the following training processes may be carried out.

An example of a suitable training dataset for training the correction neural network 508 may be the public-based database RealEstate10k.

Before training the deformation neural network 502, the weights may be randomly initialized to numbers between 0.01 and 0.1, while the biases may be randomly initialized to numbers between 0.1 and 0.9.

Subsequently, the first observations of the dataset may be loaded into the input layer of the neural network and the output value(s) is generated by forward-propagation of the input values of the input layers. Afterwards the following loss function may be used to calculate loss with the output value(s):

Mean Square Error (MSE):

$$MSE = \frac{1}{n} \sum {( y - \hat{y} )}^{2} ,$$

where n represents the number of neurons in the output layer and y represents the real output value and ŷ represents the predicted output. In other words, y−ŷ represents the difference between actual and predicted output.

The weights and biases may subsequently be updated by an AdamOptimizer with a learning rate of 0.001. Other parameters of the AdamOptimizer may be set to default values. For example:
beta_1=0.9
beta_2=0.999
eps=1e-08
weight_decay=0

The steps described above may be repeated with the next set of observations until all the observations are used for training. This represents the first training epoch, and may be repeated until 10 epochs are done.

According to an embodiment which may be combined with any above-described embodiment or with any below described further embodiment, the machine learning model 106 may further include a correction neural network 508 configured to correct aberrations in the outsider perspective image 120. The correction neural network 508 may include, for example, a U-Net architecture. The correction neural network 508 may provide the advantage of removing distortions in the generated image.

According to an embodiment which may be combined with any above-described embodiment or with any below described further embodiment, the correction neural network 508 may be further configured to perform inpainting in the outsider perspective image 120. By doing so, the outsider perspective image 120 may be completed by having the empty pixels, i.e. blank regions, filled in with approximated content.

According to an embodiment which may be combined with any above-described embodiment or with any below described further embodiment, the combiner module may be configured to combine the one or more of the remapped images based on weights determined by the compositing map 520. As a result, the correction neural network 508 may receive a more complete image representing the scene as an intermediate step, thereby improving accuracy of generating the outsider perspective image 120.

According to an embodiment which may be combined with any above-described embodiment or with any below described further embodiment, training of the correction neural network 508 may, for example, be based on standard backpropagation based gradient descent. As an example how the correction neural network 508 may be trained, a training dataset may be provided to the correction neural network 508, and the following training processes may be carried out.

An example of a suitable training dataset for training the correction neural network 508 may be the public-based database RealEstate10k.

Before training the correction neural network 508, the weights may be randomly initialized to numbers between 0.01 and 0.1, while the biases may be randomly initialized to numbers between 0.1 and 0.9.

Subsequently, the first observations of the dataset may be loaded into the input layer of the neural network and the output value(s) is generated by forward-propagation of the input values of the input layers. Afterwards the following loss function may be used to calculate loss with the output value(s).

Mean Square Error (MSE):

$$MSE = \frac{1}{n} \sum {( y - \hat{y} )}^{2} ,$$

where n represents the number of neurons in the output layer and y represents the real output value and ŷ represents the predicted output. In other words, y−ŷ represents the difference between actual and predicted output.

The weights and biases may subsequently be updated by an AdamOptimizer with a learning rate of 0.001. Other parameters of the AdamOptimizer may be set to default values. For example:
beta_1=0.9
beta_2=0.999
eps=1e-08
weight_decay=0

The steps described above may be repeated with the next set of observations until all the observations are used for training. This may represent the first training epoch, and may be repeated until 10 epochs are done.

FIG. 4 shows a block diagram of an example of the neural network 400, according to various embodiments. The neural network 400 may include an architecture that is modified based on a fully convolutional network. The neural network 400, may include a U-shaped encoder-decoder network architecture. The neural network 400 may include a plurality of encoder blocks 422 forming an encoder network, also referred to as a contracting path. The neural network 400 may further include a plurality of decoder blocks 424 forming a decoder network, also referred to as an expansive path. The encoder network 402 may halve the spatial dimensions of its input while doubling the number of filters, i.e. feature channels, at each encoder block 422. The decoder network 404 may double the spatial dimensions and halve the number of feature channels at each decoder block 424.

The encoder block 402 may be configured to extract features from the input data, and may be further configured to learn an abstract representation of the input data through the sequence of encoder blocks 422. Each encoder block 422 may include two 3×3 convolution layers 430, and each convolution layer may be followed by a Rectified Linear Unit (ReLU) activation function 432. The ReLU activation function 432 may introduce non-linearity to better generalize the training data. The output of the ReLU activation function 432 may serve as a skip connection 406 for the corresponding decoder block 424. The skip connections 406 may provide additional information that helps the decoder block 424 to generate improved semantic features. The skip connections 406 may also help the indirect flow of gradients to the earlier layers without any degradation. In other words, the skip connection 406 may help in better flow of gradient in backpropagation, which helps the neural network 400 to learn representation.

The neural network 400 may further include 2×2 max-pooling 408, that reduces the spatial dimensions (height and width) of the feature maps generated by a preceding encoder block 422 by half. This reduces the computational cost by decreasing the number of trainable parameters. The neural network 400 may further include a bridge 410 that connects the encoder network 402 to the decoder network 404. The bridge 410 may include two 3×3 convolution layers 430, where each convolution layer 430 is followed by a ReLU activation function 432, similar to the encoder block 422.

The decoder network 404 may be configured to generate a semantic segmentation mask based on the abstract representation output by the encoder network 402. The decoder network 404 may include a 2×2 transpose convolution layers 440 between every two successive decoder blocks 424. Each decoder block 424 may be receive feature map through the skip connection 406 from the corresponding encoder block 422. Each decoder block 424 may include two 3×3 convolution layers 430. Each convolution layer 430 may be followed by a ReLU activation function 432. The output of the last decoder block 424 may pass through a 1×1 convolution 440 with sigmoid activation. The sigmoid activation function may give the segmentation mask representing the pixel-wise classification.

The quantity of input channels to the neural network 400 may be three times the number of virtual surfaces 240. The quantity of output channels may be three.

The loss function used for the neural network 400 may be mean square error (MSE). As an example, the neural network 400 may be trained using the Adam optimizer, with a learning rate of 0.0001, and other parameters set to default, and trained for 10 epochs.

According to an embodiment which may be combined with any above-described embodiment or with any below described further embodiment, the neural network 400 may include the U-Net architecture. Information on the U-Net architecture may be found in “U-Net: Convolutional Networks for Biomedical Image Segmentation” by Ronneberger et. al.

According to an embodiment which may be combined with any above-described embodiment or with any below described further embodiment, the neural network 400 may be trained using an input training dataset that includes a set of images or feature maps re-rendered in a common coordinate frame, a desired pose in a coordinate frame centered on the object 202. The ground truth outsider perspective images taken around the object 202 may be provided to the neural network 400 as a training signal. Generating the re-rendered images or feature maps may include re-projecting the input images captured by SV cameras, using the first projection module 102 and the second projection module 104. The neural network 400 may be trained to correlate the ground truth outsider perspective images to the re-rendered images or feature maps in the common coordinate frame.

According to an embodiment which may be combined with any above-described embodiment or with any below described further embodiment, the training method for training the neural network 400, may include masking off pixels corresponding to the data collection vehicle, and the object 202, in the ground truth outsider perspective images. The data collection vehicle may refer to a tool that used to carry a camera for capturing the ground truth outsider perspective images. For example, the data collection vehicle may be the movable arm 704 or the movable device 750 shown in FIGS. 7A and 7B.

FIG. 5 shows a block diagram of the machine learning model 106 according to various embodiments. In these embodiments, the machine learning model 106 may include a deformation neural network 502 instead of the neural network 400. The deformation neural network 502 may differ from the neural network 400, in that it may generate a deformation map 510 and a compositing map 520 based on the transformed dataset 114 instead of directly generating the outsider perspective image 120. Advantageously, the computational resources required for the deformation neural network 502 may be lower than that of the neural network 400.

The machine learning model 106 may further include a mapping module 504 and a combiner module 506. The deformation neural network 502 may generate the deformation map 510 for the input images 110 by correlating the different projections of the input images 110 in the transformed dataset 114. The deformation neural network 502 may be trained using the same training input data as the neural network 400, but using ground truth 3D information (instead of ground truth perspective outsider images) as the training signal. The ground truth 3D information may include synthetic training data, such as those generated by the CARLA simulator. The mapping module 504 configured to re-map images in transformed dataset 114 based on the deformation map 510, to generate a set of remapped images. The machine learning model 106 may further include a combiner module 506 configured to combine one or more of the remapped images to generate an initial outsider perspective image 512 based on the compositing map 520. The combiner module 506 may combine the remapped images using a weighted average, where the weights may be determined by the compositing map 520. In some embodiments, the outsider perspective image 120 may include the initial outsider perspective image 512.

According to an embodiment which may be combined with any above-described embodiment or with any below described further embodiment, the deformation neural network 502 may include a deep learning network for deformable image registration (DIRNet). Information on the DIRNet may be found in “End-to-end Unsupervised Deformable Image Registration with a Convolutional Neural Network” by Bob D. de Vos et. al.

According to an embodiment which may be combined with any above-described embodiment or with any below described further embodiment, the machine learning model 106 may further include a correction neural network 508. The correction neural network 508 may receive the initial outsider perspective image 512, and may correct aberrations and inpainting on the initial outsider perspective image 512, to generate a final outsider perspective image 514. In some embodiments, the outsider perspective image 120 may include the final outsider perspective image 514.

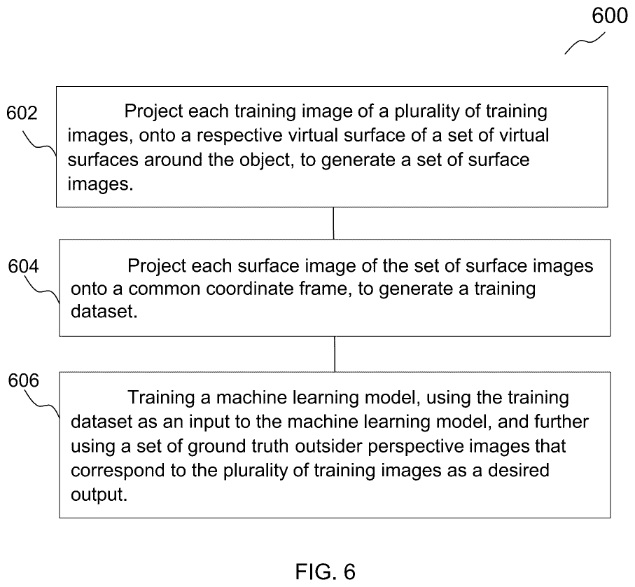

FIG. 6 shows a flow diagram of a method 600 for training a machine learning model, according to various embodiments. The method 600 may include processes 602, 604, and 606. The process 602 may include projecting each training image of a plurality of training images that captured surroundings of a training object 702 (shown in FIGS. 7A and 7B), onto a respective virtual surface 240 of a set of virtual surfaces 240 around the training object 702, to generate a set of surface images. The process 604 may include projecting each surface image of the set of surface images onto a common coordinate frame, to generate a training dataset. The process 606 may include training the machine learning model, using the training dataset as an input to the machine learning model, and further using a set of ground truth outsider perspective images that correspond to the plurality of training images as a desired output.

According to an embodiment which may be combined with any above-described embodiment or with any below described further embodiment, the method 600 may further include obtaining a training dataset that includes the plurality of training images and the set of ground truth outsider perspective images.

FIGS. 7A and 7B show examples of equipment set-up for collecting the ground truth outsider perspective images. The equipment may also be referred herein as a data collection vehicle. Referring to FIG. 7A, the ground truth outsider perspective images may be collected using a movable arm 704 mounted to the training object 702. The training object 702 may be for example, a car, and the movable arm 704 may be attached to a roof of the car. The movable arm 704 may have a first end 742 and a second end 744 opposite to the first end. The first end 742 may be coupled to the training object 702, while the second end 744 may be coupled to an external sensor 706. The movable arm 704 may be rotatable at the first end 742, to move the external sensor 706 around the training object 702 for the external sensor 706 to capture ground truth outsider perspective images from various angles around the training object 702. The movable arm 704 may include a plurality of segments 722 connected by rotatable joints 724, such that the position of the external sensor 706 is adjustable by displacing any segment 722 relative to another segment 722 about a connected rotatable joint 724.

Referring to FIG. 7B, the ground truth outsider perspective images may be collected using a movable device 750 fitted with an external sensor 706. The movable device 750 may be for example, a robot, or an unmanned ground vehicle. The movable device 750 may be driven around the training object 702, for the external sensor 706 to capture outsider perspective images from various angles around the training object 702.

According to an embodiment which may be combined with any above-described embodiment or with any below described further embodiment, the method 600 may further include preprocessing the training dataset. The preprocessing of the training dataset may include performing intrinsic and/or extrinsic calibration of the surround view cameras, for example, sensors 204, and third person cameras, for example, the external sensors 706. In the event that the pose and temporal alignment of the external sensor 706 is unknown, the preprocessing may include jointly estimating the temporal offsets and the trajectory of the external sensor 706 by formulating a calibration alignment problem. This may be necessary, if for example, the exact position of the movable arm 704 or the movable device 750 is unknown.

The preprocessing in the method 600 may include removing segments of the images collected by the external sensor 706. These segments may include pixels showing the training object 702, the movable arm 704 or the movable device 750.

To remove the training object 702 from the training images collected by the external sensor 706, a binary mask may be created for each image, using a specifically trained auxiliary neural network. The binary mask may indicate which pixels in the collected image belong to the training object 702. Removing the training object 702 from the training images may allow the machine learning model 106 to be trained for any generic object, for example, any vehicle model.

Further, the collected image may also include glimpses of the movable arm 704 or the movable device 750. A mask may be created to cover pixels showing the movable arm 704 or the movable device 750. An infilling neural network may create plausible image data in place of the covered pixels.

Optionally, the method 600 may further include applying a depth estimation algorithm (for example, stereo vision or monocular depth estimation), or an additional sensor such as a radar, or LiDAR sensor, to generate a 3D model of the scene. The method 600 may further include transforming surface images into the common coordinate frame based on the 3D model. By doing so, the resulting transformed dataset may be used as a weak ground truth for training the machine learning model 106, without the use of heuristics or neural networks to generate the transformed dataset.

The method 600 may further include creating adaptive virtual surfaces based on the 3D model of the scene.

The training images may be captured by sensors 204 mounted on the training object 702. The method 600 may include projecting and re-projecting the training images in the similar processes as described with respect to FIG. 1A by the first projection module and the second projection module.

According to an embodiment which may be combined with any above-described embodiment or with any below described further embodiment, the machine learning model 106 shown in FIG. 1A may be trained using the method 600.

According to an embodiment which may be combined with any above-described embodiment or with any below described further embodiment, the method 600 may further include masking off the training object from the set of ground truth outsider perspective images, before using the set of ground truth outsider perspective images as the desired output for training the machine learning model. This allows the machine learning model 106 to be trained without bias with respect to the object type of the object 202, for example, the vehicle model. This may allow the method to be applied to any type of object.

According to an embodiment which may be combined with any above-described embodiment or with any below described further embodiment, the method 600 may further include defining each virtual surface 240 of the set of virtual surfaces 240 as a mesh before projecting each training image of the plurality of training images onto the respective virtual surface 240. The method 600 may further include backpropagating the set of surface images onto the meshes. The method 600 may further include determining output of a loss function based on the backpropagation, to refine the set of virtual surfaces 240.

According to various embodiments, a data structure generated by the method 600 may be provided. The data structure may include a trained machine learning model, such as the machine learning model 106.

While embodiments of the present disclosure have been particularly shown and described with reference to specific embodiments, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced. It will be appreciated that common numerals, used in the relevant drawings, refer to components that serve a similar or the same purpose.

It will be appreciated to a person skilled in the art that the terminology used herein is for the purpose of describing various embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for generating an outsider perspective image, the method comprising:
receiving a plurality of input images that capture surroundings of an object;
projecting each input image of the plurality of input images, onto a respective virtual surface of a set of virtual surfaces around the object to generate a set of surface images, and
projecting each surface image of the set of surface images onto a common coordinate frame, to generate a transformed dataset; and
generating, by a machine learning model, an outsider perspective image based on the transformed dataset.

2. The method of claim 1, further comprising:
generating a synthetic image of the object based on a three-dimensional virtual model of the object; and
adding the synthetic image of the object to the outsider perspective image.

3. The method of claim 1, wherein the machine learning model comprises a fully convolutional neural network.

4. The method of claim 1, wherein the machine learning model comprises
a deformation neural network configured to generate a deformation map and a compositing map based on the transformed dataset,
a mapping module configured to map each surface image of the set of surface images based on the deformation map, to generate a set of remapped images, and
a combiner module configured to combine one or more of the remapped images based on the compositing map, to generate the outsider perspective image.

5. The method of claim 1, wherein the machine learning model further comprises a correction neural network configured to correct aberrations in the outsider perspective image.

6. The method of claim 1, wherein the correction neural network is further configured to perform inpainting in the outsider perspective image.

7. The method of claim 1, wherein the combiner module is configured to combine the one or more of the remapped images based on average of weights determined by the compositing map.

8. A computer-implemented training method for training a machine learning model, the method comprising:
projecting each training image of a plurality of training images that capture surroundings of a training object, onto a respective virtual surface of a set of virtual surfaces around the training object to generate a set of surface images;
projecting each surface image of the set of surface images onto a common coordinate frame, to generate a training dataset; and
training the machine learning model, using the training dataset as an input to the machine learning model, and further using a set of ground truth outsider perspective images that correspond to the plurality of training images as a training signal.

9. The training method of claim 8, further comprising:
masking off the training object from the set of ground truth outsider perspective images, before using the set of ground truth outsider perspective images as the desired output for training the machine learning model.

10. The training method of claim 8, further comprising:
defining each virtual surface of the set of virtual surfaces as a mesh before projecting each training image of the plurality of training images onto the respective virtual surface;
backpropagating the set of surface images onto the meshes; and
determining output of a loss function based on the backpropagation, to refine the set of virtual surfaces.

11. The method of claim 1, wherein the machine learning model is trained according to a computer-implemented training method for training a machine learning model, the method comprising:
projecting each training image of a plurality of training images that capture surroundings of a training object, onto a respective virtual surface of a set of virtual surfaces around the training object to generate a set of surface images;
projecting each surface image of the set of surface images onto a common coordinate frame, to generate a training dataset; and
training the machine learning model, using the training dataset as an input to the machine learning model, and further using a set of ground truth outsider perspective images that correspond to the plurality of training images as a training signal.

12. A device for generating an outsider perspective image, the device comprising a processor configured to perform a method for generating an outsider perspective image, the method comprising:
receiving a plurality of input images that capture surroundings of an object;
projecting each input image of the plurality of input images, onto a respective virtual surface of a set of virtual surfaces around the object to generate a set of surface images, and
projecting each surface image of the set of surface images onto a common coordinate frame, to generate a transformed dataset; and
generating, by a machine learning model, an outsider perspective image based on the transformed dataset.

13. The device of claim 12, further comprising:
a plurality of sensors, wherein each sensor of the plurality of sensors is configured to capture a respective input image of the plurality of input images.

14. The device of claim 12, further comprising:
a vehicle, wherein the object includes the vehicle.
